(19) United States
(12) Patent Application Publication
(10) Pub. No.: US 2022/0335411 A1
(43) Pub. Date: Oct. 20, 2022

(54) SYSTEM FOR BINDING A VIRTUAL CARD NUMBER

(71) Applicant: Capital One Services, LLC, McLean, VA (US)

(72) Inventors: Jeffrey Carlyle Wieker, Fairfax, VA (US); Daniel Waling Van Winkle, Washington, DC (US)

(21) Appl. No.: 17/230,256

(22) Filed: Apr. 14, 2021

(51) Int. Cl. G06Q 20/34; G06N 20/00

(52) U.S. Cl. CPC G06Q 20/351; G06N 20/00

(57) ABSTRACT

Aspects described herein allow for systems and methods for binding a virtual card number (VCN) based on a customer's purchasing behavior. A machine classifier or machine learning algorithm may be utilized to analyze the customer's purchasing behavior to determine when to bind an unbound VCN to one or more of the merchants that the customer has used the unbound VCN. The customer's purchasing behavior may include one or more of the following: VCN transaction information to include the merchant, what was purchased, and when it was purchased; and time factors to include time between purchases in general or time between purchases at a specific merchant.

### FIELD OF USE

Aspects of the disclosure relate generally to virtual card numbers. More specifically, aspects of the disclosure may provide for systems and methods for binding a virtual card number.

### BACKGROUND

As online payments become increasingly common, financial institutions seek new ways to give customers more control over how their financial information is used online. Virtual card numbers are a convenient way to make credit card purchases online. Virtual card numbers (VCNs) are sometimes referred to as virtual credit cards or virtual cards and they allow the customer to shop online without giving merchants the customer's actual credit card number.

VCNs may be utilized as substitutes for an actual credit card number. The VCNs are still linked to the customer's credit card account, but allow the customer to use a different number to fill out payment information when the customer shops online. This means a customer's actual credit card is never given to the websites where the customer shops—adding another layer of security.

Aspects described herein may address these and other problems, and generally improve the quality, efficiency, and speed of customers spending their reward points.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein allow for systems and methods for binding a virtual card number (VCN) based on a customer's purchasing behavior. A machine classifier or machine learning algorithm may be utilized to analyze the customer's purchasing behavior to determine when to bind an unbound VCN to one or more of the merchants that the customer has used the unbound VCN. The customer's purchasing behavior may include one or more of the following: VCN transaction information to include the merchant, what was purchased, and when it was purchased; and time factors to include time between purchases in general or time between purchases at a specific merchant.

More particularly, some aspects described herein may provide a computer-implemented method, the method comprising: training, by a virtual card number server, a machine classifier for binding a virtual card number (VCN) based on one or more inputs; determining, by the machine classifier, the correlation between the customer purchasing behavior and the unbound VCN, wherein the correlation between the customer purchasing behavior and the unbound VCN predicts that the unbound VCN will not be used at a new merchant outside of the one or more unbound merchants for the one or more transactions; and binding, by the VCN server and based on the determined correlation from the machine classifier, the unbound VCN, thereby creating a bound VCN to one or more bound merchants, wherein the bound VCN is utilized for one or more bound transactions at only the one or more bound merchants. The training may include: creating, by a VCN server, an unbound VCN, wherein the unbound VCN is utilized by a customer for one or more transactions at one or more unbound merchants; and receiving, by the VCN server, the one or more inputs comprising a customer purchasing behavior that includes transaction information about the one or more transactions using the unbound VCN, the transaction information including a merchant name, one or more purchase items, and a transaction date and time. Additionally, the trained machine classifier is configured to determine a pattern of purchase behaviors associated with the unbound VCN, the one or more transactions, and the one or more unbound merchants that indicates a potential correlation between the customer purchasing behavior and the unbound VCN.

According to some embodiments, the customer purchasing behavior may further include one or more additional VCNs created by the customer. The customer purchasing behavior may further include the transaction information for the one or more additional VCNs. The customer purchasing behavior may further include the transaction information for one or more primary account number (PAN) transactions using a primary account number (PAN) of the customer. The customer purchasing behavior may further include transaction time factors from one or more of the following: a time between the one or more transactions using the unbound VCN by the customer, a time between any purchase by the customer, a time between the one or more transactions using the unbound VCN at a specific merchant, a time from a first purchase to a last purchase, or an arbitrary time determined by the VCN server. Additionally, the arbitrary time may be 30 days. The customer purchasing behavior may further include one or more of the following: transaction time factors from one or more of the following: a time between the one or more transactions using the unbound VCN by the customer, a time between any purchase by the customer, a time between the one or more transactions using the unbound VCN at a specific merchant, a time from a first purchase to a last purchase, or an arbitrary time determined by the VCN server; one or more additional VCNs created by the customer; the transaction information for the one or more additional VCNs; or the transaction information for one or more primary account number (PAN) transactions using a primary account number (PAN) of the customer. The one or more inputs may further include other customer VCN purchasing behaviors that includes the transaction information about one or more transactions for other customers. The method may also include the step of requesting and receiving, by the VCN server, merchant data for the one or more bound transactions utilizing the bound VCN. Additionally, the method may include the step of approving, by the VCN server, the one or more transactions if the merchant data matches the one or more bound merchants. Additionally, the method may include the step of declining, by the VCN server, the one or more transactions if the merchant data does not match the one or more bound merchants. The method may also include the step of sending, by the VCN server, a real-time communication to the customer regarding the binding of the unbound VCN to the bound VCN.

Additionally, other aspects described herein may provide a system for binding a virtual card number (VCN) comprising: a VCN server including one or more processors, the VCN server creating an unbound VCN, wherein the unbound VCN is utilized by a customer for one or more transactions at one or more unbound merchants. The system may also include memory storing instructions that, when executed by the VCN server, cause the system to: train, by the VCN server, a machine classifier based on one or more inputs comprising a customer purchasing behavior; determine, by the machine classifier, the correlation between the customer purchasing behavior and the unbound VCN; bind, by the VCN server and based on the determined correlation from the machine classifier, the unbound VCN, thereby creating a bound VCN to one or more bound merchants; and send, by the VCN server, a real-time communication to the customer regarding the binding of the unbound VCN to the bound VCN. Additionally, the customer purchasing behavior may include: transaction information about the one or more transactions using the unbound VCN, the transaction information including a merchant name, one or more purchase items, and a transaction date and time; transaction time factors from one or more of the following: a time between the one or more transactions using the unbound VCN by the customer, a time between any purchase by the customer, a time between the one or more transactions using the unbound VCN at a specific merchant, a time from a first purchase to a last purchase, or an arbitrary time determined by the VCN server; one or more additional VCNs created by the customer; the transaction information for the one or more additional VCNs; and the transaction information for one or more primary account number (PAN) transactions using a primary account number (PAN) of the customer. The trained machine classifier may be configured to determine a pattern of purchase behaviors associated with the unbound VCN, the one or more transactions, and the one or more unbound merchants that indicates a potential correlation between the customer purchasing behavior and the unbound VCN. The correlation between the customer purchasing behavior and the unbound VCN may predict that the unbound VCN will be used at no new merchants. The bound VCN may be utilized for one or more bound transactions at only the one or more bound merchants.

Additionally, other aspects described herein may provide one or more non-transitory media storing instructions that, when executed by one or more processors, cause a server to perform steps comprising: training, by a virtual card number server that creates an unbound virtual card number (VCN), a machine classifier based on one or more inputs; receiving, by the VCN server, the one or more inputs comprising a customer purchasing behavior; determining, by the machine classifier, the correlation between the customer purchasing behavior and the unbound VCN; binding, by the VCN server and based on the determined correlation from the machine classifier, the unbound VCN, thereby creating a bound VCN to one or more bound merchants; requesting and receiving, by the VCN server, merchant data for the one or more bound transactions utilizing the bound VCN; approving, by the VCN server, the one or more transactions if the merchant data matches the one or more bound merchants; and declining, by the VCN server, the one or more transactions if the merchant data does not match the one or more bound merchants. The unbound VCN may be utilized by a customer for one or more transactions at one or more unbound merchants. The customer purchasing behavior may include transaction information and one or more transaction time factors. The transaction information may include one or more transactions using the unbound VCN, the transaction information including a merchant name, one or more purchase items, and a transaction date and time. The one or more transaction time factors may include one or more of the following: a time between the one or more transactions using the unbound VCN by the customer, a time between any purchase by the customer, a time between the one or more transactions using the unbound VCN at a specific merchant, a time from a first purchase to a last purchase, or an arbitrary time determined by the VCN server. The trained machine classifier may be configured to determine a pattern of purchase behaviors associated with the unbound VCN, the one or more transactions, and the one or more unbound merchants that indicates a potential correlation between the customer purchasing behavior and the unbound VCN. The correlation between the customer purchasing behavior and the unbound VCN may predict that the unbound VCN will be used at no new merchants. The bound VCN may be utilized for one or more bound transactions at only the one or more bound merchants.

Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example financial system with a credit card server and a virtual card number server that may be used in implementing one or more aspects of the disclosure in accordance with one or more illustrative aspects discussed herein;

FIG. 3 depicts an example process chart for a system for binding a virtual card number based on customer purchasing behaviors according to one or more aspects of the disclosure; and

FIG. 4 depicts a flow chart for a method of binding a virtual card number based on customer purchasing behaviors according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and systems for binding a virtual card number based on a customer's purchasing behavior. Some credit card companies give the customer a unique virtual card number (VCN) for every website where the customer shops, which may be referred to as binding the VCN to one or more merchants. Those bound VCNs cannot be used anywhere else other than the bound merchants. If a merchant site is compromised, there is no way the VCN can be used to make purchases elsewhere. The VCN cannot be used to access the customer's account data on the card issuer's application or website either. Customers can use their credit card accounts to create multiple VCNs, which transact normally and work just like regular credit cards. The customer may be able to control (by binding the VCN) the merchants at which VCNs can be used. A VCN decision system may approve a transaction if the merchant data for the bound merchant matches the merchant data for the merchant where a transaction is being requested (and declines those transactions where the VCN decision system detects the merchants do not match). For example, if a customer creates a VCN that is bound to Merchant #1 and later that VCN is used to attempt a transaction at Merchant #2, the VCN decision system may decline this transaction. This capability, called “merchant binding,” leads to a substantial reduction in fraud rates.

A machine classifier or machine learning algorithm may be utilized to analyze the customer's purchasing behavior to determine when to bind the unbound VCN to one or more of the merchants that the customer has used the unbound VCN.

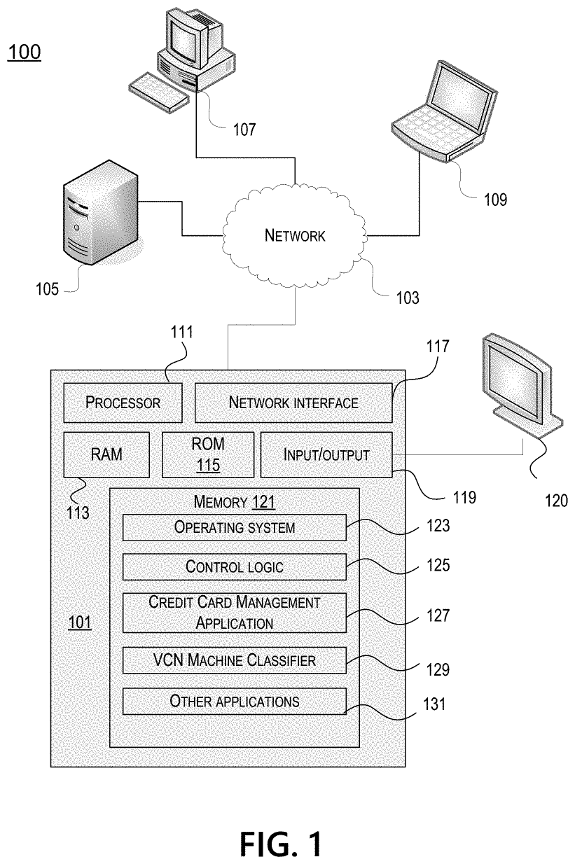

Before discussing these concepts in greater detail, however, several examples of a computing device that may be used in implementing and/or otherwise providing various aspects of the disclosure will first be discussed with respect to FIG. 1.

FIG. 1 illustrates one example of a virtual card number server 101 as a computing device that may be used to implement one or more illustrative aspects discussed herein. For example, the virtual card number server 101 may, in some embodiments, implement one or more aspects of the disclosure by reading and/or executing instructions and performing one or more actions based on the instructions. In some embodiments, the virtual card number server 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

The virtual card number server 101 may, in some embodiments, operate in a standalone environment. In others, the virtual card number server 101 may operate in a networked environment. As shown in FIG. 1, various devices 101, 105, 107, and 109 may be interconnected as network nodes via a network 103, such as the Internet. Other networks may also or alternatively be used, including private intranets, corporate networks, LANs, wireless networks, personal networks, and the like. Network 103 is for illustration purposes and may be replaced with fewer or additional computer networks. A local area network (LAN) may have one or more of any known network topologies and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, the virtual card number server 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring the virtual card number server 101 into a special purpose computing device in order to perform one or more of the various functions discussed herein. Memory 121 may store operating system software 123 for controlling overall operation of the virtual card number server 101, control logic 125 for instructing the virtual card number server 101 to perform aspects discussed herein, a credit card management application 127, a VCN machine classifier 129, and other applications 131. The VCN machine classifier 129 may be a machine learning algorithm without departing from this invention. Control logic 125 may be incorporated in and may be a part of one or more of the credit card management application 127 or the VCN machine classifier 129. In several embodiments, the virtual card number server 101 may include two or more of any and/or all of these components (e.g., two or more processors, two or more memories, etc.) and/or other components and/or subsystems not illustrated here.

Devices 105, 107, 109 may have similar or different architecture as described with respect to the virtual card number server 101. Those of skill in the art will appreciate that the functionality of the virtual card number server 101 (or device 105, 107, 109) as described herein may be spread across multiple data processing devices, for example, to distribute processing load across multiple computers, to segregate transactions based on geographic location, user access level, quality of service (QoS), etc. For example, the virtual card number server 101 and devices 105, 107, 109, and others may operate in concert to provide parallel computing features in support of the operation of control logic 125 and/or the credit card management application 127 or the VCN machine classifier 129.

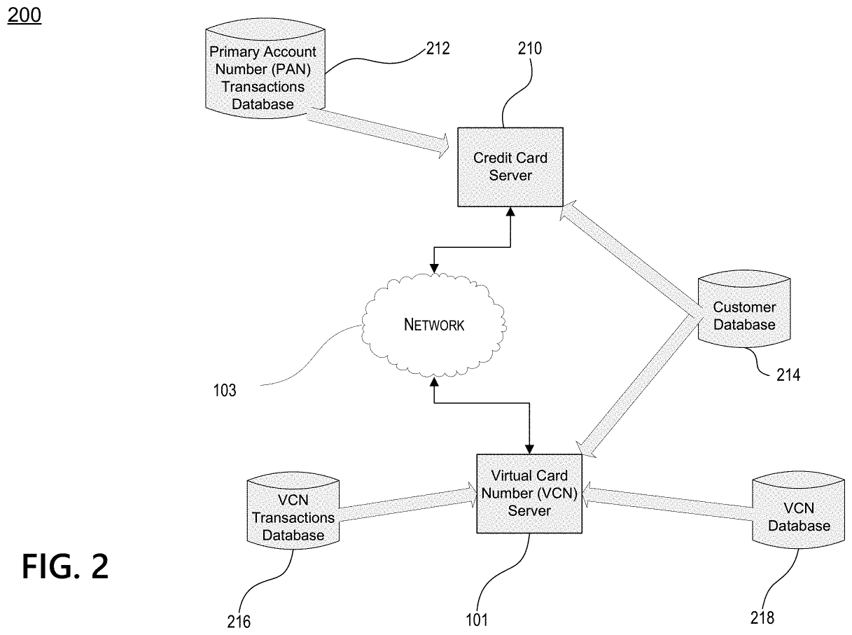

FIG. 2 illustrates an exemplary financial system 200 with a credit card server 210 and the virtual card number server 101 from FIG. 1. The credit card server 210 and the virtual card number server 101 may, in some embodiments, operate in a standalone environment. In many embodiments, the credit card server 210 and the reward virtual card number server 101 may operate in a networked environment. As shown in FIG. 2, the credit card server 210 and the virtual card number server 101 may be interconnected as network nodes via a network 103, such as the Internet. Other networks may also or alternatively be used, including private intranets, corporate networks, LANs, wireless networks, personal networks, and the like. Network 103 is for illustration purposes and may be replaced with fewer or additional computer networks. A local area network (LAN) may have one or more of any known network topologies and may use one or more of a variety of different protocols, such as Ethernet. The credit card server 210 and the virtual card number server 101 may be connected to one or more of the networks 103 via twisted pair wires, coaxial cable, fiber optics, radio waves or other communication media.

As illustrated in FIG. 2, a customer database 214 may be connected to both the credit card server 210 and the virtual card number server 101. The customer database 214 may include various information regarding the customers in the financial system 200. The customer database 214 may include information about the customers such as: name, address, date of birth, social security number, primary account number, virtual account numbers, other account information, and any other information about the customers. As illustrated in FIG. 2, both the credit card server 210 and/or the virtual card number server 101 may pull the customer information from the customer database 214.

Additionally, a primary account number (PAN) transaction database 212 may be connected to the credit card server 210. The PAN transaction database 212 may include information and data related to the PAN transactions, such as any of the transactions related to the primary account number for the customers. These PAN transactions may include one or more of the following: credit card transactions using the PAN or debit card transactions using the PAN. Other PAN transactions associated with the primary account number may be included in the PAN transaction database 212.

Additionally, a virtual card number (VCN) transaction database 216 may be connected to the virtual card number server 101. The VCN transaction database 216 may include information and data related to any of the VCN transactions, such as any of the transactions related to the virtual card numbers for the customers. These VCN transactions may include one or more of the following: unbound VCN transactions or bound VCN transactions using the VCN. Other VCN transactions associated with the virtual card number may be included in the VCN transaction database 216.

Additionally, a virtual card number (VCN) database 218 may be connected to the virtual card number server 101. The VCN database 218 may include information and data related to the virtual card numbers, to include both unbound virtual card numbers and bound virtual card numbers. The VCN database 218 can sort and filter the unbound virtual card numbers and the bound virtual card numbers from each of the various customers.

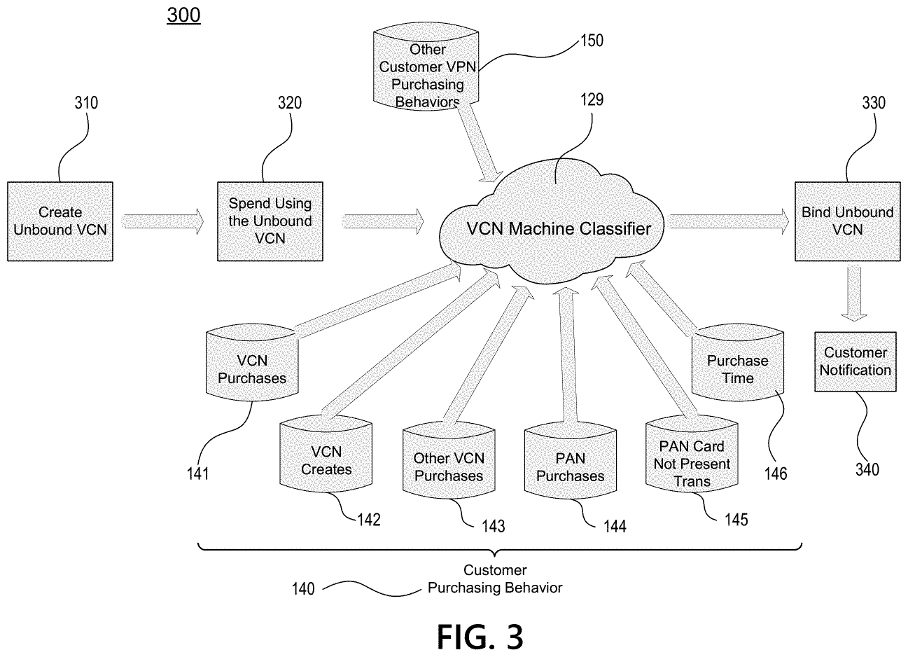

FIG. 3 illustrates an exemplary process flow 300 for binding a virtual card number based on customer purchasing behaviors. As shown in FIG. 3, a customer may create an unbound VCN 310 for use with a merchant. The customer can use a VCN just like an actual credit card—just shop online, start the checkout process, and use a VCN to make the purchase. VCNs typically work with any online merchant that accepts credit card payments. The customers information may be maintained and stored in the customer database 214. The customer database 214 may include various information regarding the customers in the financial system 200 such as: customer name, customer address, customer date of birth, customer social security number, customer primary account number, customer virtual account numbers, other account information, and any other information about the customers. The unbound VCNs may be maintained and stored in the virtual card number (VCN) database 218, which may include information and data related to the virtual card numbers, to include both unbound virtual card numbers and bound virtual card numbers.

The customer may create an unbound VCN as compared to creating a bound VCN. If an unbound VCN is created, many times a customer makes a couple purchases, including recurring and non-recurring purchases on a VCN, then does not make any purchases at new merchants. During this process, the customer may create multiple VCNs and make other purchases on other VCNs and their physical card (online and in person). When a VCN is created, the customer may not know what he/she really wants in reference to binding. Many times, it is simplest for the customer to either create an unbound VCN or to create a first authorized bound VCN.

Next, the customer may start spending using the unbound VCN 320. If a customer can shop online with an actual credit card, the customer can probably shop online with a VCN. The VCN may be linked to the customer's credit card account. Most VCNs may also require a tool, such as a browser extension, an application or a downloadable program of some kind. Once the customer is set up, the customer can typically shop online like normal using the VCN. When it is time to check out, the tool may generate VCNs for the customer. The tool can also store and retrieve VCNs for the next time the customer shops. VCNs can make online shopping easier and more secure. VCNs may add another layer of protection to the customer's credit card account in case a site where a credit card number is stored is ever compromised. VCNs can give a customer extra confidence when making a purchase at a website the customer has not used before. If fraudulent activity or a data leak does happen with the merchant or website, the customer's actual card number is protected. Additionally, instead of reentering the actual card number each time the customer checks out, the customer can use VCNs to auto-fill payment information to save time.

If a VCN is being used, the financial system 200 may utilize a VCN machine classifier 129 to bind an unbound VCN based on a customer's purchasing behavior 140. As illustrated in FIG. 3, the VCN machine classifier 129 may receive and process data from various sources, such as those data sources identified as customer purchasing behavior 140 and other customer VPN purchasing behaviors 150.

The customer purchasing behavior 140 may include one or more of the following inputs, for example: VCN purchases 141, VCN card creates 142, other VCN purchases 143, primary account number (PAN) purchases 144, PAN card not present transactions 145, and purchase time 146.

Specifically, VCN purchases 141 may include the purchase information and transactions for the purchases made by the customer using the specific VCN, such as VCN #1. This VCN #1 purchase information 141 and transactions may include the merchant, what was purchased, and when it was purchased using VCN #1. The VCN purchases 141 may be stored in the VCN transaction database 216.

VCN card creates 142 may include the information related to any time the customer creates a new VCN, such as the customer creating other VCNs. The VCN card creates 142 may be stored in the VCN transaction database 216.

Other VCN purchases 143 may include the purchase information and transactions related to the customer using other VCNs to make purchases, such as VCN #2, VCN #3, and/or VCN #4. This other VCN purchase 143 information and transactions may include the merchant, what was purchased, and when it was purchased using other VCNs, such as VCN #2, VCN #3, and/or VCN #4. The other VCN purchases 143 may be stored in the VCN transaction database 216.

Primary account number (PAN) purchases 144 may include the purchase information and transactions related to the customer using their primary account number (PAN) for purchases. This PAN purchases 144 purchase information and transactions may include the merchant, what was purchased, and when it was purchased using the PAN card. A primary account number (PAN) transaction database 212 may include and store the PAN purchase information 144. The PAN transaction database 212 may include information and data related to the PAN transactions, such as any of the transactions related to the primary account number for the customers. These PAN transactions may include one or more of the following: credit card transactions using the PAN or debit card transactions using the PAN. Other PAN transactions associated with the primary account number may be included in the PAN transaction database 212.

PAN card not present transactions 145 may include the purchase information and transactions related to the customer transactions that do not include the customer's PAN card. This PAN card not present 145 purchase information and transactions may include the merchant, what was purchased, and when it was purchased without the PAN card present.

Purchase time 146 may include the time between purchases. Purchase time 146 may include a variety of times, such as between purchases in general, between purchases at a specific merchant, time between first purchase to last purchase. The purchase time 146 may be an arbitrary time, such as 30 days.

In many embodiments, the VCN machine classifier 129 may provide that the VCN purchases 141 and purchase time 146 are the most important inputs to determine a customer purchasing behavior for the VCN machine classifier 129. The VCN purchases 141 and purchase time 146 may be utilized alone with the VCN machine classifier 129 or may be weighted higher than the other inputs into the VCN machine classifier 129.

The VCN machine classifier 129 may provide data munging, parsing, and machine learning models to help determine when to bind the unbound VCN to one or more merchants that a customer has made purchases at. As was described above, the machine classifier 129 may utilize one or more of a variety of machine learning architectures known and used in the art These architectures can include, but are not limited to, decision trees, k-nearest, neighbors, support vector machines (SVM), neural networks (NN), recurrent neural networks (RNN), convolutional neural networks (CNN), transformers, and/or probabilistic neural networks (PNN). RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, and/or genetic scale RNNs. In a number of embodiments, a combination of machine classifiers can be utilized, more specific machine classifiers when available, and general machine classifiers at other times can be used. The machine classifier 129 may do one or more of the following: filter purchasing behaviors, flatten data and match to configure data, store transaction information and data in one or more databases, and/or match and cluster the various transaction information and data.

The financial system 200 may utilize the VCN machine classifier 129 to learn and to determine when to bind an unbound VCN based on a customer's purchasing behavior 140. The financial system 200 may bind the unbound VCN to one or more merchants 330, thereby creating a bound VCN. The bound VCNs may be maintained and stored in the virtual card number (VCN) database 218, which may include information and data related to the virtual card numbers, to include both unbound virtual card numbers and bound virtual card numbers. The financial system 200 may automatically bind the unbound VCN to one or more merchants 330 based on the VCN machine classifier 129 and the customer's purchasing behavior 140. In a variety of embodiments, the financial system 200 may require either customer or financial institution approval prior to binding the unbound VCN to one or more merchants 330.

In one example, the customer purchasing behavior 140 may include a customer who makes all purchases are under one VCN. In this instance, the VCN machine classifier 129 may proceed with a slow binding rate as the customer utilizes the VCN for various merchants and binding that VCN to one or more merchants may limit the spending and purchasing for that particular customer. In another example, the customer purchasing behavior may include a customer who makes one purchase and then requests a new VCN. In this instance, the VCN machine classifier 129 may proceed with a faster or fast binding rate as the customer utilizes each of the VCNs for individual purchases and therefore at specific individual merchants, where binding that VCN to the one specific merchant may not limit the spending and purchasing for this particular customer.

As illustrated in FIG. 3, after binding the unbound VCN 330, the financial system 200 may send a notification 340 to the customer. The notification 340 may be real-time or near real-time to the customer. The notification 340 may include an email or text or other communication to the customer of the binding of the unbound VCN 330. Additionally, the customer may be able to participate in an “opt out” program for the VCN automatic binding via communications such as email, text, or other mobile communications. Further, the financial system 200 or the virtual card number server 101 may send a notification 340 of the automatic binding of the VCN to one or more merchants via email, text, or other mobile communications.

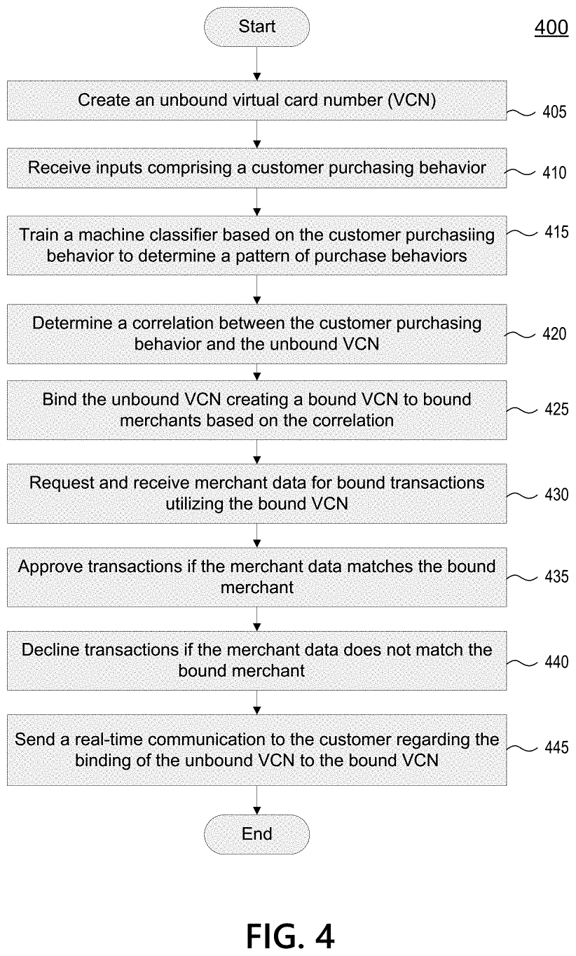

FIG. 4 illustrates an example method 400 for binding a virtual card number (VCN) based on one or more inputs and specifically purchasing behavior. Method 400 may be implemented by a suitable computing system, as described further herein. For example, method 400 may be implemented by any suitable computing environment by a computing device and/or combination of computing devices, such as the virtual card number server 101 and/or devices 105, 107, and 109 of FIG. 1. Method 400 may be implemented in suitable program instructions, such as provided by the financial system 200, the virtual card number server 101, and the credit card server 210, executing the VCN machine classifier 129 on the credit card management application 127. In a variety of embodiments, some or all of the steps described below may be combined and/or divided into sub-steps as appropriate. It will be readily appreciated that other steps may be included in this method, and that not all steps are necessary in all situations.

At step 405, the financial system 200 and the virtual card number server 101 may create an unbound virtual card number (VCN) associated with a customer and a primary account number (PAN) for the customer. The unbound VCNs may be maintained and stored in the virtual card number (VCN) database 218, which may include information and data related to the virtual card numbers, to include both unbound virtual card numbers and bound virtual card numbers. The unbound VCN may be utilized by the customer for one or more transactions at one or more unbound merchants. The customer and customer information may be stored in a customer database 214 which may include various information regarding the customers in the financial system 200. The customer database 214 may include information about the customers such as: name, address, date of birth, social security number, primary account number, virtual account numbers, other account information, and any other information about the customers.

At step 410, the financial system 200 and the virtual card number server 101 may receive inputs comprising a customer purchasing behavior. The customer purchasing behavior may include transaction information about the one or more transactions using the unbound VCN. The transaction information may include a merchant name, one or more purchase items, and a transaction date and time. The one or more inputs may also include other customer VCN purchasing behaviors that includes transaction information about one or more transactions for other customers. The customer purchasing behavior may further include one or more additional VCNs created by the customer and the transaction information for the one or more additional VCNs. The VCN transaction information may be stored in the VCN transaction database 216, such as any of the transactions related to the virtual card numbers for the customers.

The customer purchasing behavior may also include the transaction information for one or more primary account number (PAN) transactions using a primary account number (PAN) of the customer. The PAN transactions may be stored in the PAN database 212 and may include information and data related to the PAN transactions, such as any of the transactions related to the primary account number for the customers.

Additionally, the customer purchasing behavior may include transaction time factors from one or more of the following: a time between the one or more transactions using the unbound VCN by the customer, a time between any purchase by the customer, a time between the one or more transactions using the unbound VCN at a specific merchant, a time from a first purchase to a last purchase, or an arbitrary time determined by the VCN server. The arbitrary time for purchase transaction history may be, for example, 5 days, 10, days, 20 days, or 30 days. Other time limits maybe utilized without departing from this invention.

At step 415, the financial system 200 and the virtual card number server 101 may train a machine classifier 129 based on the one or more inputs and the customer purchasing behavior to determine a pattern of purchase behaviors. The machine classifier 129 may be configured to determine the pattern of purchase behaviors associated with the unbound VCN, the one or more transactions, and the one or more unbound merchants. The pattern of purchase behaviors may indicate a potential correlation between the customer purchasing behavior and the unbound VCN.

At step 420, the financial system 200 and the virtual card number server 101 may determine the correlation between the customer purchasing behavior and the unbound VCN based on the pattern of purchase behaviors. The correlation between the customer purchasing behavior and the unbound VCN may predict that the unbound VCN will not be used at a new merchant outside of the one or more unbound merchants for the one or more transactions.

At step 425, the financial system 200 and the virtual card number server 101 may bind the unbound VCN creating a bound VCN to bound merchants based on the correlation between the customer purchasing behavior and the unbound VCN. The bound VCNs may be maintained and stored in the virtual card number (VCN) database 218, which may include information and data related to the virtual card numbers, to include both unbound virtual card numbers and bound virtual card numbers. The bound VCN may be utilized for one or more bound transactions at only the one or more bound merchants.

At step 430, the financial system 200 and the virtual card number server 101 may request and receive merchant data for bound transactions utilizing the bound VCN. At step 435, the financial system 200 and the virtual card number server 101 may approve transactions if the merchant data matches the bound merchant. At step 440, the financial system 200 and the virtual card number server 101 may decline transactions if the merchant data does not match the bound merchant.

At step 445, the financial system 200 and the virtual card number server 101 may send a communication to the customer regarding the binding of the unbound VCN to the bound VCN. The communication may be a real-time communication or notification. The real-time communication or notification may include an email or text or other communication to the customer of the automatic binding of the VCN to one or more merchants.

In a number of embodiments, the financial system 200 and the virtual card number server 101 may provide the unbound/bound VCN transaction information and the VCN machine classifier pattern of purchase behaviors to a fraud system or fraud algorithm. The fraud system or fraud algorithm may be configured to determine how a specific number or VCN was compromised. Not only are VCNs convenient, VCNs are one way a customer can be protected from credit card fraud. VCNs also can help limit how much information is accessible to fraudsters if customer information is stolen in a phishing scam or a data breach. For example, when VPNs show up fraudulent at a merchant, the binding of the virtual card number by the financial system 200 and the virtual card number server 101 will help feed the fraud system or fraud algorithm and help with fraud prevention.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A computer-implemented method, the method comprising:
training, by a virtual card number server, a machine classifier for binding a virtual card number (VCN) based on one or more inputs, the training including:
creating, by a VCN server, an unbound VCN, wherein the unbound VCN is utilized by a customer for one or more transactions at one or more unbound merchants; and
receiving, by the VCN server, the one or more inputs comprising a customer purchasing behavior that includes transaction information about the one or more transactions using the unbound VCN, the transaction information including a merchant name, one or more purchase items, and a transaction date and time;
wherein the trained machine classifier is configured to determine a pattern of purchase behaviors associated with the unbound VCN, the one or more transactions, and the one or more unbound merchants that indicates a potential correlation between the customer purchasing behavior and the unbound VCN;
determining, by the machine classifier, the correlation between the customer purchasing behavior and the unbound VCN, wherein the correlation between the customer purchasing behavior and the unbound VCN predicts that the unbound VCN will not be used at a new merchant outside of the one or more unbound merchants for the one or more transactions;
binding, by the VCN server and based on the determined correlation from the machine classifier, the unbound VCN, thereby creating a bound VCN to one or more bound merchants, wherein the bound VCN is utilized for one or more bound transactions at only the one or more bound merchants.

2. The method of claim 1, wherein the customer purchasing behavior further includes one or more additional VCNs created by the customer.

3. The method of claim 2, wherein the customer purchasing behavior further includes the transaction information for the one or more additional VCNs.

4. The method of claim 1, wherein the customer purchasing behavior further includes the transaction information for one or more primary account number (PAN) transactions using a primary account number (PAN) of the customer.

5. The method of claim 1, wherein the customer purchasing behavior further includes transaction time factors from one or more of the following: a time between the one or more transactions using the unbound VCN by the customer, a time between any purchase by the customer, a time between the one or more transactions using the unbound VCN at a specific merchant, a time from a first purchase to a last purchase, or an arbitrary time determined by the VCN server.

6. The method of claim 5, wherein the arbitrary time is 30 days.

7. The method of claim 1, wherein the customer purchasing behavior further includes one or more of the following: transaction time factors from one or more of the following: a time between the one or more transactions using the unbound VCN by the customer, a time between any purchase by the customer, a time between the one or more transactions using the unbound VCN at a specific merchant, a time from a first purchase to a last purchase, or an arbitrary time determined by the VCN server; one or more additional VCNs created by the customer; the transaction information for the one or more additional VCNs; or the transaction information for one or more primary account number (PAN) transactions using a primary account number (PAN) of the customer.

8. The method of claim 1, wherein the one or more inputs further includes other customer VCN purchasing behaviors that includes the transaction information about one or more transactions for other customers.

9. The method of claim 1, further including:
requesting and receiving, by the VCN server, merchant data for the one or more bound transactions utilizing the bound VCN.

10. The method of claim 9, further including:
approving, by the VCN server, the one or more transactions if the merchant data matches the one or more bound merchants.

11. The method of claim 10, further including:
declining, by the VCN server, the one or more transactions if the merchant data does not match the one or more bound merchants.

12. The method of claim 1, further including:
sending, by the VCN server, a real-time communication to the customer regarding the binding of the unbound VCN to the bound VCN.

13. A system for binding a virtual card number (VCN) comprising:
a VCN server including one or more processors, the VCN server creating an unbound VCN, wherein the unbound VCN is utilized by a customer for one or more transactions at one or more unbound merchants;
memory storing instructions that, when executed by the VCN server, cause the system to:
train, by the VCN server, a machine classifier based on one or more inputs comprising a customer purchasing behavior, the customer purchasing behavior including: transaction information about the one or more transactions using the unbound VCN, the transaction information including a merchant name, one or more purchase items, and a transaction date and time; transaction time factors from one or more of the following: a time between the one or more transactions using the unbound VCN by the customer, a time between any purchase by the customer, a time between the one or more transactions using the unbound VCN at a specific merchant, a time from a first purchase to a last purchase, or an arbitrary time determined by the VCN server; one or more additional VCNs created by the customer; the transaction information for the one or more additional VCNs; and the transaction information for one or more primary account number (PAN) transactions using a primary account number (PAN) of the customer,
wherein the trained machine classifier is configured to determine a pattern of purchase behaviors associated with the unbound VCN, the one or more transactions, and the one or more unbound merchants that indicates a potential correlation between the customer purchasing behavior and the unbound VCN;
determine, by the machine classifier, the correlation between the customer purchasing behavior and the unbound VCN, wherein the correlation between the customer purchasing behavior and the unbound VCN predicts that the unbound VCN will not be used at a new merchant outside of the one or more unbound merchants for the one or more transactions;
bind, by the VCN server and based on the determined correlation from the machine classifier, the unbound VCN, thereby creating a bound VCN to one or more bound merchants, wherein the bound VCN is utilized for one or more bound transactions at only the one or more bound merchants; and
send, by the VCN server, a real-time communication to the customer regarding the binding of the unbound VCN to the bound VCN.

14. The system of claim 13, wherein the one or more inputs further includes other customer VCN purchasing behaviors that includes the transaction information about one or more transactions for other customers.

15. The system of claim 13, wherein the arbitrary time is 30 days.

16. The system of claim 13, wherein the memory storing instructions that, when executed by the VCN server, cause the system to further:
request and receive, by the VCN server, merchant data for the one or more bound transactions utilizing the bound VCN.

17. The system of claim 16, wherein the memory storing instructions that, when executed by the VCN server, cause the system to further:
approve, by the VCN server, the one or more transactions if the merchant data matches the one or more bound merchants; and
decline, by the VCN server, the one or more transactions if the merchant data does not match the one or more bound merchants.

18. One or more non-transitory media storing instructions that, when executed by one or more processors, cause a server to perform steps comprising:
training, by a virtual card number server that creates an unbound virtual card number (VCN), a machine classifier based on one or more inputs, wherein the unbound VCN is utilized by a customer for one or more transactions at one or more unbound merchants;
receiving, by the VCN server, the one or more inputs comprising a customer purchasing behavior, the customer purchasing behavior includes transaction information and one or more transaction time factors, wherein the transaction information includes one or more transactions using the unbound VCN, the transaction information including a merchant name, one or more purchase items, and a transaction date and time, and further wherein the one or more transaction time factors include one or more of the following: a time between the one or more transactions using the unbound VCN by the customer, a time between any purchase by the customer, a time between the one or more transactions using the unbound VCN at a specific merchant, a time from a first purchase to a last purchase, or an arbitrary time determined by the VCN server,
wherein the trained machine classifier is configured to determine a pattern of purchase behaviors associated with the unbound VCN, the one or more transactions, and the one or more unbound merchants that indicates a potential correlation between the customer purchasing behavior and the unbound VCN;
determining, by the machine classifier, the correlation between the customer purchasing behavior and the unbound VCN, wherein the correlation between the customer purchasing behavior and the unbound VCN predicts that the unbound VCN will not be used at a new merchant outside of the one or more unbound merchants for the one or more transactions;
binding, by the VCN server and based on the determined correlation from the machine classifier, the unbound VCN, thereby creating a bound VCN to one or more bound merchants, wherein the bound VCN is utilized for one or more bound transactions at only the one or more bound merchants;
requesting and receiving, by the VCN server, merchant data for the one or more bound transactions utilizing the bound VCN;
approving, by the VCN server, the one or more transactions if the merchant data matches the one or more bound merchants; and
declining, by the VCN server, the one or more transactions if the merchant data does not match the one or more bound merchants.

19. The one or more non-transitory media storing instructions of claim 18, wherein the customer purchasing behavior further includes one or more of the following: one or more additional VCNs created by the customer; the transaction information for the one or more additional VCNs; or the transaction information for one or more primary account number (PAN) transactions using a primary account number (PAN) of the customer.

20. The one or more non-transitory media storing instructions of claim 18, wherein the one or more inputs further includes other customer VCN purchasing behaviors that includes the transaction information about one or more transactions for other customers.
